(19) United States
(12) Patent Application Publication
(10) Pub. No.: US 2019/0226051 A1
(43) Pub. Date: Jul. 25, 2019

(54) SYSTEM AND METHOD FOR RECYCLING METALS FROM INDUSTRIAL WASTE

(71) Applicant: PM POWER GROUP, White Pine, MN (US)

(72) Inventors: Raymond Mark Pierpoint, White Pine, MN (US); Zachary Jon Halkola, Hubbell, MI (US); Brenton Harold Zettl, Saskatoon (CA)

(21) Appl. No.: 16/327,308

(22) PCT Filed: Aug. 22, 2017
(86) PCT No.: PCT/US17/47920

§ 371 Date: Feb. 21, 2019

Related U.S. Application Data
(60) Provisional application No. 62/377,828, filed on Aug. 22, 2016.

(51) Int. Cl. C22B 7/00; B09B 3/00

(52) U.S. Cl. CPC C22B 7/00; B09B 2220/08; B09B 3/0058

(57) ABSTRACT

A system and method for recycling metals from industrial waste using an electrodepositing technique. The method includes the steps of collecting the industrial waste, transporting, processing and digesting the waste in a solvent or acidic solution and then electrodepositing out the desired metals. Other processing steps may be used to prepare the industrial waste for electrodeposition and the process may be repeated on the digest solution, to obtain multiple metals.

### CROSS-REFERENCE TO RELATED APPLICATION

This application claims the benefit of U.S. Provisional Patent Application Ser. No. 62/377,828, filed Aug. 22, 2016, the entire disclosure of the application being considered part of the disclosure of this application and hereby incorporated by reference.

### FIELD OF THE INVENTION

A system and method for recycling metals from industrial waste using a refinery process. More specifically, a method of obtaining industrial waste, transporting, processing and digesting the waste in a solvent or acidic solution and then refining out desired metals. The process may then be repeated using the same feedstock to refine out other desired metals.

### BACKGROUND OF THE DISCLOSURE

A variety of industrial waste streams include metals that are currently directed to landfills or other waste facilities where the metals are not recovered due to the complexity and cost required to recover the metals. In addition, as many facilities that produce industrial waste containing metals are spread out or geographically separated and each facility may produce a limited quantity of waste that includes metals, to date it is not cost efficient or effective to attempt to capture such waste. One such source of metals in industrial waste streams is tool and die or other machine shops or facilities. Many of these shops or facilities include facility or machine specific filters that capture waste, including metal that is produced during a manufacturing process or use. For example, many machine shops include a variety of metal process tools, such as cutting tools, including metal lathes and drills that use fluid as a lubricant. The fluid keeps the port and cutting surface cool and removes debris from the machine. Most machines include a filter that captures shavings and other particles. As such, these filters capture metals that are currently disposed of into the waste streams and eventually make their way into landfills. To date due to the geographical separation, lack of volume from any facility, lack of collection mechanism, and variety of types of waste, no current mechanism or system exists to collect such waste efficiently.

### SUMMARY OF THE INVENTION

A system and method for recycling metals from industrial waste using an electrodepositing technique. The method includes the steps of collecting the industrial waste, transporting, processing and digesting the waste in a solvent or acidic solution and then electrodepositing out the desired metals. Other processing steps may be used to prepare the industrial waste for electrodeposition and the process may be repeated on the digest solution, to obtain multiple metals.

The present invention is generally directed to a method of recovering metals from a waste material, such as stampings, tailings, filters and other industrial waste containing metals of desire. The method includes the steps of collecting the waste material; processing the waste material; digesting the processed waste material into a solution; and electrodepositing a first metal from the solution to create a solid metal product. If the waste material is filters, the filters generally are industrial filters such as EDM filters or other filters used to filter out metal contaminants from machine fluids, such as cutting lubricants. If the industrial filter includes a casing, end caps or other items to hold the filter media, the step of processing the industrial filter forming the waste material may include a step of separating the such materials, such as the outer casing, from the filter media, such that only the filter media is digested as the processed waste material in said step of digesting. The step of digesting the filter media as the waste material includes the step of placing the filter media into at least one of an acid or peroxide, with the acid being selected relative to desired metal to be digested, such as sulfuric acid. In some instances, it is desirable to use the sulfuric acid in combination the hydrogen peroxide. Other acids may have improved digestion for other metals.

The present invention includes a step of digestion after the step of processing the industrial waste. The step of digestion includes a step of electrodepositing includes the steps of electrowinning by depositing ions of the first metal onto a cathode or anode, such as a stainless steel cathode. The step of electrodepositing the first metal to create a solid metal product includes the steps of depositing the ions of the first metal onto the stainless steel cathode to create a greater than 99% pure solid metal product. The present invention may even create a purity level of 99.99% or greater of copper cathodes. The step of electrowinning continues until the solution formed in the digesting step of substantially depleted of ions of the first metal, such as copper. The step of electrowinning may be reperformed to electrodeposit a second metal from the solution to create a second solid metal product, such as zinc, until the solution is substantially depleted of ions. As the solution is depleted of ions, the cathode grows slower as less ions of the desired metal are available. For example, it may be desirable to stop when the solution is substantially depleted with 09%, 95% or even 99% of available copper is already attached to the cathode or anode. The step of electrowinning may be reperformed for each additional metal to be electrodeposited from solution to create additional solid metal products. The present invention may further include steps of at least one of heating and stirring during the digesting step. A filtration step and/or carbon absorption step may be added. The carbon absorption step may be performed between said digesting and said electrodepositing steps and wherein said carbon absorption step removes organic materials from the solution. The filtration step may remove solids from the solution. In some instances, the first digestion step could be part of the processing step and configured to remove iron ions, with the filtration step capturing any metals that were dislodged as solids from the filter media. The filtration step if configured then to remove copper rich solids from an iron rich solution during said step processing, or an initial step of digesting, which would occur before digesting for the desired metal.

The present invention may also include as part of the processing steps, at least one step of stamping, milling, and iron pretreatment steps. These steps are optional and may be used depending on the type of sample. For example, the stamping and milling steps may not be necessary for industrial filters as the waste stream.

The present invention may be further directed to a method of recovering metals from industrial filters having a filter media comprising the steps of: collecting the industrial filters; processing the industrial filters in preparation for digestion; digesting the industrial filters into an acidic solution to transfer copper ions from the industrial filters into the acidic solution; and electrodeposition the copper ions from the solution onto an electrode in the solution.

The method may further include the step of separating the filter media from any outer casings on the industrial filters. The step of processing may further include step of pretreating the filter media to remove iron materials before said step of digesting. The step of pretreating may include magnetic removal of iron materials or other method of iron removal. The step of pretreating includes the step of inserting the filter media into an acid and peroxide bath and separating copper rich solids from the iron solution. The processing step may further include a carbon column filtration step to remove organic materials. In addition, the step of electrodeposition may include the step of electrowinning the metal ions from the acidic solution. More specifically, a cell configured to hold the acidic solution or digest solution containing the metal ions has an anode and cathode placed into the cell. Of course, the process may start before digestion is complete, which allows faster cycle times. As ions leave the industrial waste during the digestion step, the electrodeposition step may occur at the same time, and wherein said step of electrowinning includes circulating the acidic solution in the cell past the anode and cathode to improve purity of a copper being electrodeposited onto the electrode and reducing time required to fully perform said electrodeposition step. The method of the present invention, including the above step of circulating allows at least 99.9% or greater purity of copper in a solution including multiple metal ions in addition to the copper ions. A second electrodeposition step to remove zinc ions from the solution onto an electrode and wherein said solution is substantially free of copper ions. The method may further including performing additional electrodeposition steps to remove additional metal ions from the solution onto an electrode and wherein said solution is substantially free of copper and zinc ions.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is an illustration of an exemplary filter;

FIG. 2 is an illustration of an exemplary EDM machine and filter;

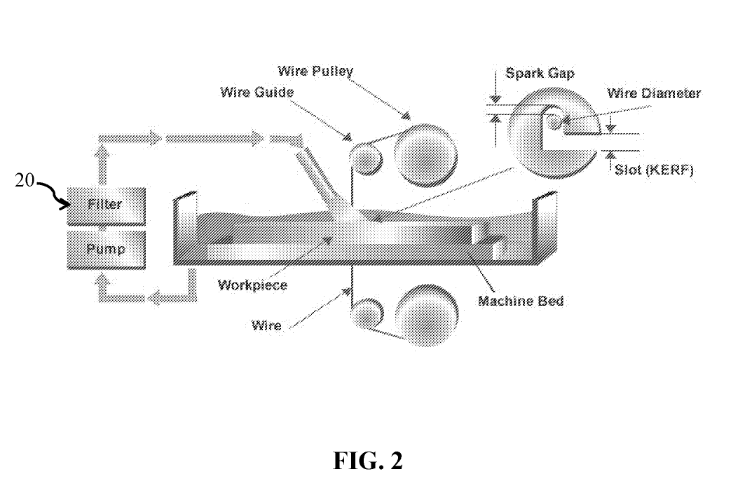

FIG. 3 is a flowchart of an exemplary process;

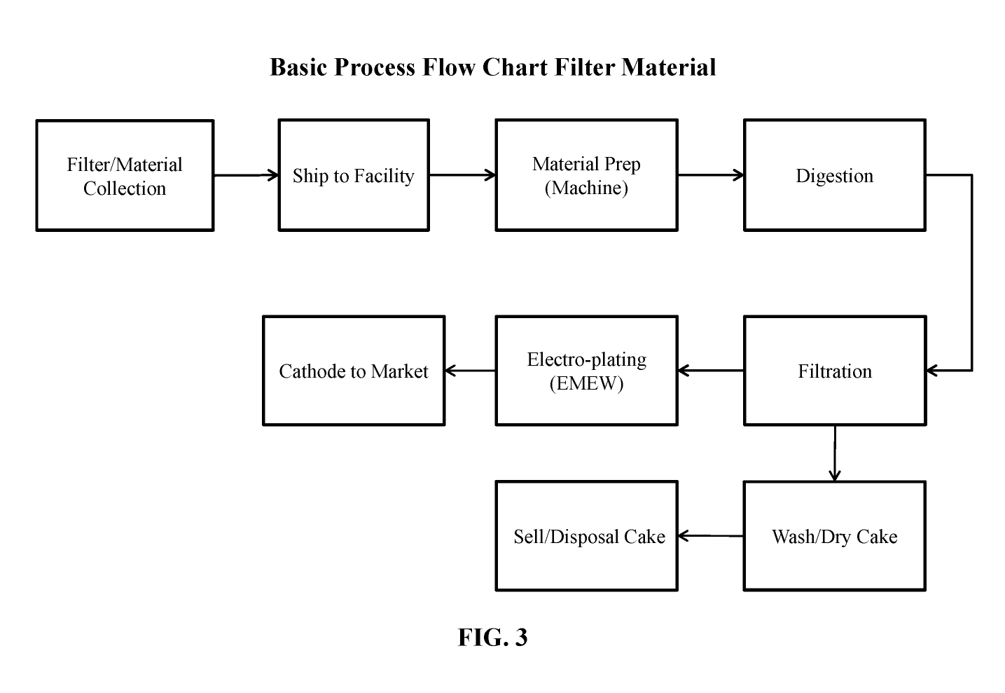

FIG. 4 is a flowchart of an exemplary process;

FIG. 5 is a flowchart of an exemplary process;

FIG. 6 is a flowchart of an exemplary process;

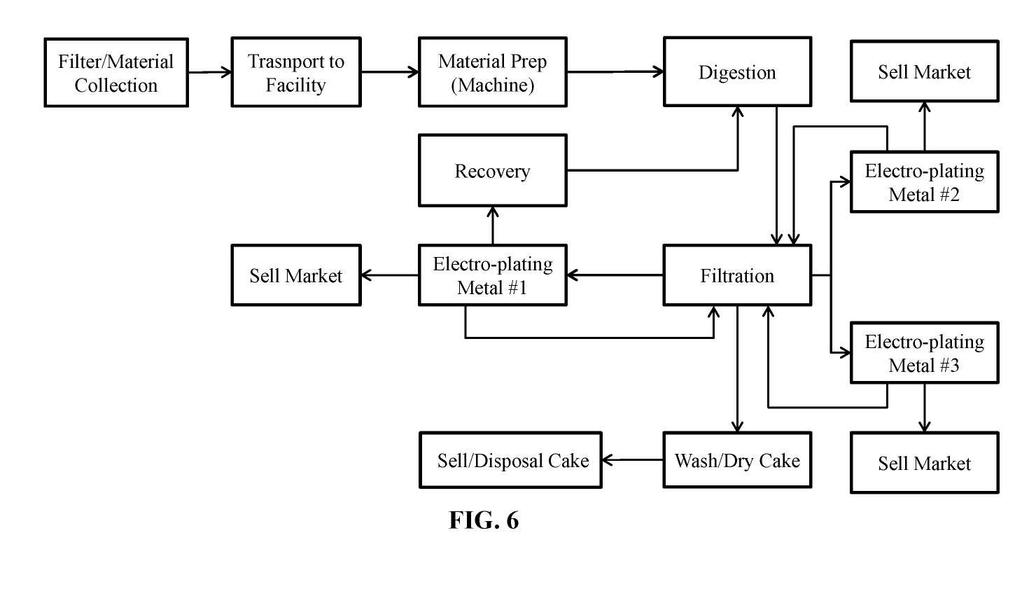

FIG. 7 is a flowchart of an exemplary process; and

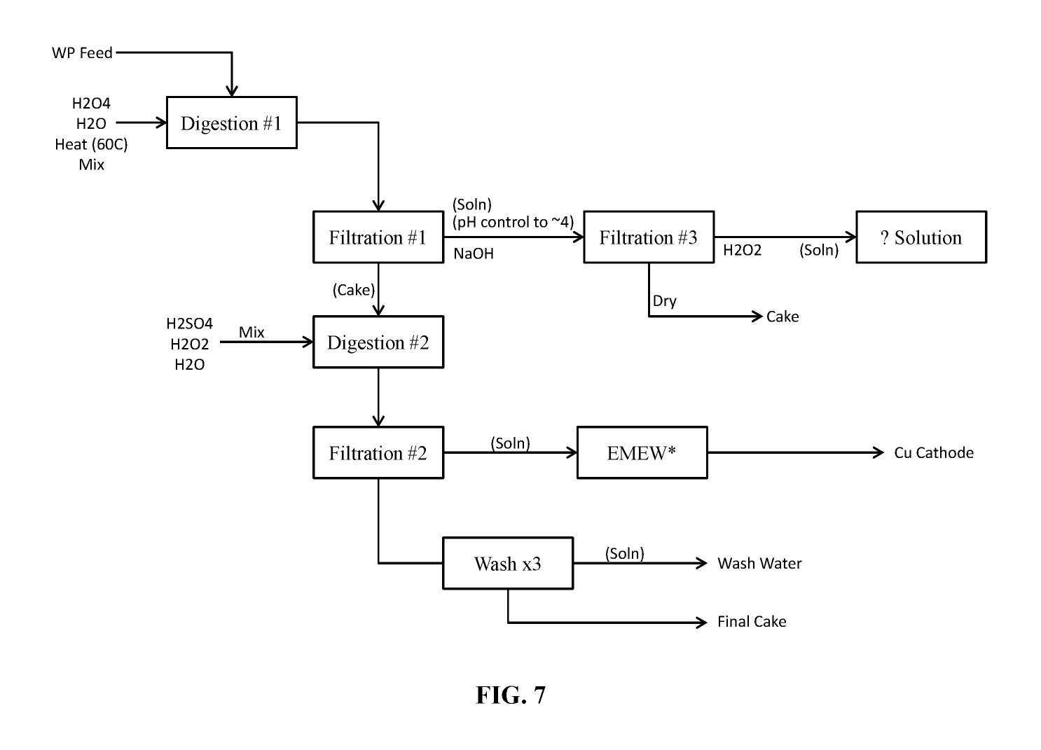

FIG. 8 is a flowchart of an exemplary process.

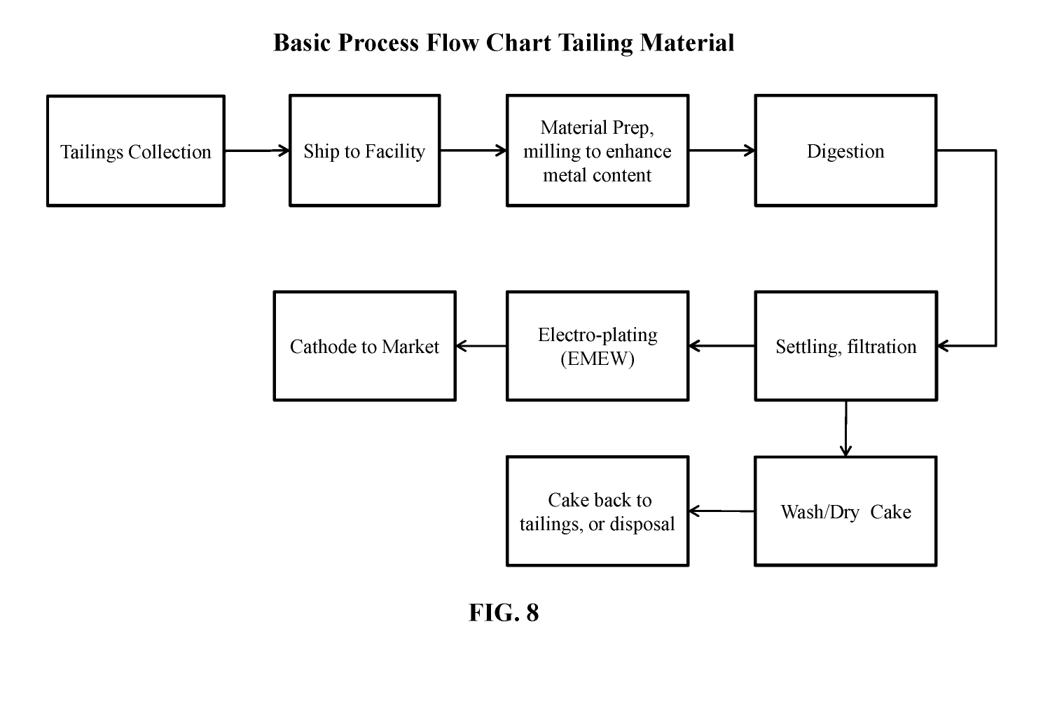

### DESCRIPTION OF THE EXAMPLE EMBODIMENTS

The present invention is generally directed to a system and method for recovering metals from industrial waste streams using a refinery process. More specifically, the method includes the steps of acquiring a waste source, such as the illustrated filter and material collection; transporting the waste source preparation of the waste source for digestion; digestion of the materials in the waste product, particularly digestion of metals from other waste materials in the waste source; filtration by specific metal (which may be part of the digestion step); electroplating the desired metals into at least one cathode (which may include the filtration step); selling the resulting metals that have been purified and formed into finished product; and disposing of the remaining waste materials after the desired metals have been removed. The metals expected to be removed by the present invention include copper, zinc, iron, silver gold, platinum, palladium, or other precious metals. The process may be adapted to include any other desirable metals capable of being refined or plated out of a solution including such metals. In addition, the process of the present invention can even be used in remediation to remove heavy metals from industrial and mining byproducts, including stamp sands and tailings. As such, while the source material may be filters as described above, stamp sands, slag, tailings and other waste materials and streams may be easily processed to remove metals, all of which reduces environmental issues with such industrial and mining waste.

In the present invention, the industrial waste must be collected, which has traditionally been expensive and ineffective. The industrial waste material may include any waste or by-product that includes metals, such as stamp sands, tailing and other waste products that normally are sent to landfills due to complicated or costly recovery processes to remove the metals. One waste product that to date has not been recycled are industrial filters, such as those used on industrial machines that process, form, or cut metal, including electrical discharge manufacturing (EDM) filters, metal drills, CNC machines, and other metal cutting machines. While some operators reclaim and recycle the large metal shavings, the smaller particulates that are caught by the filter have not yet been recycled due to the difficulty in obtaining any scale of recovery of the metals. Most trapped metals in such filters are small particles of various metals that are impractical to separate and recover at least in a cost efficient and effective manner. As each individual filter contains a very limited amount of metals and each facility uses a limited amount of these filters, for example a single machine may use as little as a single filter in a year or more commonly one per month, to date, with no good method of recovering the metals from the filters no one has collected the filters to recycle the metals and instead they are disposed of in a landfill.

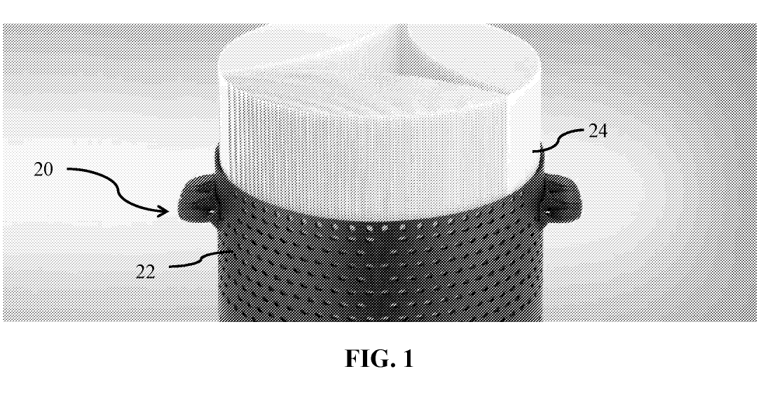

For example, the present invention uses a variety of methods to collect these filters. The filters may be collected by providing a shipping label at the time of sale, setting up a program to collect them in bulk from certain facilities, provide collection points, or use waste disposal companies to pick them up. It may be more cost effective to have companies aggregate the filters before shipping, or provide a repository at each facility and pickup once they are full. Any method of getting the filters from the source facility to the processing facility is acceptable. Industrial waste filters may have a variety of sizes, shapes and configurations. An exemplary filter 20 is illustrated in FIG. 1 having an outer casing 22 that contains the filter media 24. The filter media 24 may be formed out of a variety of materials, the most common being a pleated paper material, which fills with the debris of the industrial process.

As part of the collection step described above, the waste material, such as the illustrated filter 20 must be transported to a facility for processing. Of course, if customers drop off the waste product at the processing facility, the step of transporting is not required. Next the filters 20 or waste streams need to be processed. The waste material or filters may be prepared for digestion on site, such as cutting open the casing 22 of the filters to expose the internal filter media 24 and collected materials (including the metals), but it is expected that they will be transported from the source location as described above to an offsite location for processing. The step of processing may occur at the refinery site or at another site in preparation for the digestion step at the refinery. The step of processing may include any steps necessary or helpful to prepare the waste material for processing. For example, with an EDM filter, the processing step may cut and remove an outer filter casing 22, if present. The outer casing could also be separated, recovered and recycled as part of the processing. If the waste material is mining by-products, such as tailings, the tailings could be further stamped or milled in increase surface area to improve the efficiency of the digestion step. In some instances where the waste material 12 includes a ferrous component, the process may include a magnetic separation step to separate, recover and recycle such ferrous materials before digestion. Any other known method of separating metals may be used. Of course, the processing step is optional and everything in the waste material could just be fed into the digestion step with the desired metals recovered later. Processing may include developing machine specially designed for task to maximize efficiency. For example, if the waste material was industrial filters having an outer casing, end caps, and/or inner casing, a machine could be developed to separate these from the filter media 24, such that only the filter media is fed to the digester. Of course, it may be desirable to wash any removed components as they are separated and recovered to remove any waster material attached thereto, and to feed the results of the wash with the filter media in the digestion step. The collection, transportation and processing steps may include specialized equipment. For example, collection hoppers, equipment to move and transport them, and saws or shredding to break down, for example filters, or stamping, milling, rolling or crushing equipment for other types of waste materials.

The next process step is to digest the waste materials, such as the exemplary EDM filter. In many digestion processes, the waste product, such as filter or other waste materials is then digested in an applicable material such as an acid. The digestion process may be modified for what type of metals is desired to maximize the removal of metals into solution. In addition, the digestion process may be tailored to prevent certain components or materials of the waste product or materials from entering into the solution. For example, if the filters include copper, then the digestion process may use sulfuric acid solution. Of course, multiple digestion processes may be used on the waste material to maximize digestion of different metals. Other hydrometallurgical methods may be used, such as solvent extraction to digest material into solution. For example, hydrogen peroxide, and various acids, or other useful solvents may be used solely or in combination, either at same time or serially to remove the desirable metals. As such, the solvent or solution may be selected based on the targeted metal for extraction. In one test of the present invention, the digestion process used a 10-15% acid solution. However, in some embodiments where the waste product being processed includes high levels of iron, and iron pre-treatment step may be required if the desired metals are not iron, such as copper or zinc. Tables 1-3 below, show examples of digestion and recovery in the refining steps below.

Two assays were digested in sulfuric acid for leaching of copper. For each leach, 10.0 g of sample was digested in a 50% sulfuric acid solution and heated at or above 80° C. for 1 hr. The solutions were filtered and washed with water, and the filtrate solutions were analyzed for chromium, copper, and iron; the residues were analyzed for those metals as well as zinc.

TABLE 1
Mass Balance of Sulfuric Acid Digest

| | | Initial | | Mass of | Mass of | Recovery |
|---|---|---|---|---|---|---|
| In 50% | Mass of | Metal | Mass of | Metal in | Metal in | of Metal in |
| H₂SO₄ | Assay | Mass | Residue | Residue | Solution | Solution |
| Digest | (g) | (g) | (g) | (g) | (g) | (%) |
| Cr | / | 120 | / | 0.045 | 132.93 | 110.8 |
| Cu | / | 2880 | / | 1.826 | 856.8 | 29.75 |
| Fe | / | 2350 | / | 0.045 | 1053 | 100.4 |
| Zn | / | 1400 | / | 0.098 | n.d. | n.d. |
| Total | 10.0 | / | 2.4 | / | / | / |

TABLE 2
Mass Balance of Sulfuric Acid Digest

| | | Initial | | Mass of | Mass of | Recovery of |
|---|---|---|---|---|---|---|
| In 50% | Mass of | Metal | Mass of | Metal in | Metal in | Metal in |
| H₂SO₄ | Assay | Mass | Residue | Residue | Solution | Solution |
| Digest | (g) | (g) | (g) | (g) | (g) | (%) |
| Cr | / | 22 | / | 0.004 | 22.35 | 101.6 |
| Cu | / | 2400 | / | 1.323 | 1053 | 43.88 |
| Fe | / | 2460 | / | 0.035 | 2679 | 108.9 |
| Zn | / | 1320 | / | 0.046 | n.d. | n.d. |
| Total | 10.0 | / | 1.8 | / | / | / |

Since the break in Table 2 had the best leaching of copper into solution, a second method was tried also using hydrogen peroxide as an oxidizing agent, heating the sample at or above 90° C. for 1.5 hrs. This led to 99.9% recovery of the metal in the filtrate solution, as illustrated in Table 3 below, and is commonly the most effective method for maximizing the leaching of copper.

TABLE 3
Mass Balance of Sulfuric Acid & Peroxide Digest

| In 150 g/L | | Initial | | Mass of | Mass of | % Recovery |
|---|---|---|---|---|---|---|
| H₂SO₄ and | Mass of | Metal | Mass of | Metal in | Metal in | of Metal in |
| 20 g H₂O₂ | Assay | Mass | Residue | Residue | Solution | Solution |
| Digest | (g) | (g) | (g) | (g) | (g) | (%) |
| Cr | / | 22 | / | n.d. | 22.96 | 104.4 |
| Cu | / | 2400 | / | n.d. | 2398.5 | 99.94 |
| Fe | / | 2460 | / | n.d. | 2562.5 | 104.2 |
| Zn | / | 1320 | / | n.d. | 1264.85 | 95.82 |
| Total | 10.0 | / | 0.4 | / | / | / |

An optional step may be added to settle the solids in solution. This may simply be allowing enough time for the solids to settle, stirring the solution under heat to improve digestion or dissolving of the waste stream into the solvent or solution, adding a flocculent on cooling the solution to aid settling the solids, or a combination of the above.

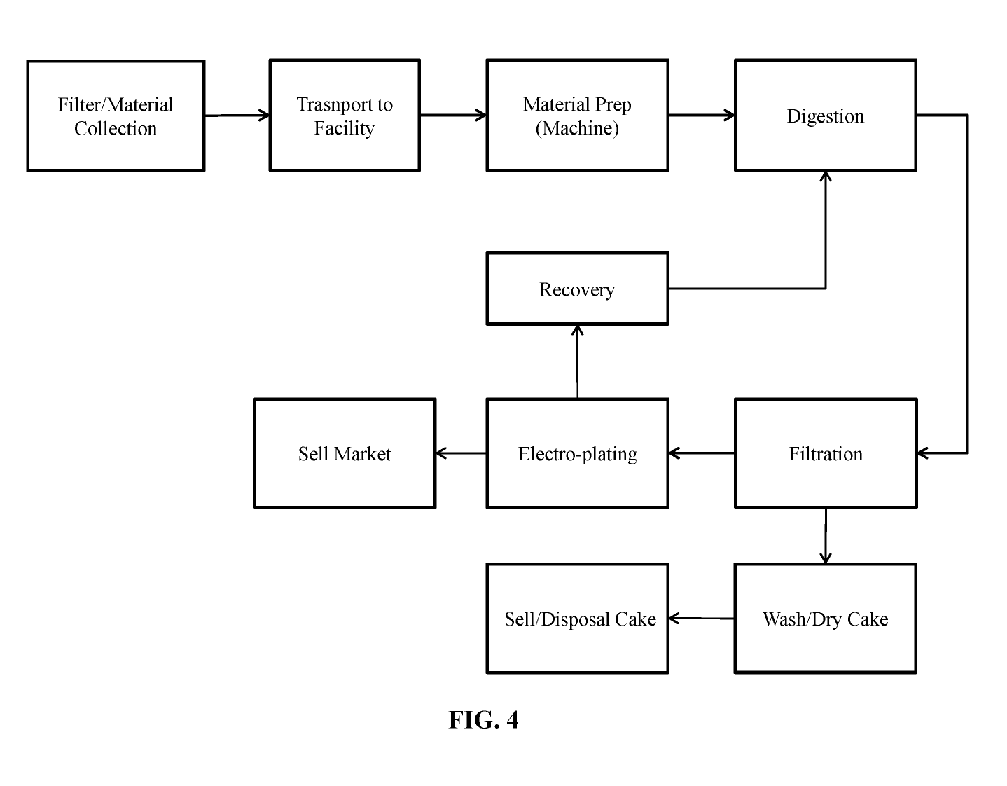

The process may include a separation step where the solutions created in the digestion step may be separated into different streams or bleed streams for processing or disposal. This may include processing steps to separate, or may just be the raw stream including a quantity of known metal being sent to an electroplating recovery process, and other streams that have already have had other metals (other than e.g., copper) being removed but including the metal of interest sent also into the electroplating recovery process. An example of such a filtration block dividing the streams of materials, including those already processed for metals is illustrated in FIG. 4. The recovery process is further described below.

In the electroplating recovery process, the current used may be selected to selectively plate a particular desired metal into a saleable metal cathode. In the present invention an EMEW electrowinning or electroextraction process is used, although other processes may be used. Electrowinning is the electrodeposition of metals from their ores that have been put in solution via a process commonly referred to as leaching. Electrorefining uses a similar process to remove impurities from a metal. Both processes use electroplating on a large scale and are important techniques for economical purification of non-ferrous metals. The resulting metals are said to be electrowon. In electrowinning, a current is passed form an inert anode through a liquid leach solution containing the metal so that the metal is extracted as it is deposited in an electroplating process onto the cathode. In electrorefining, the anodes consist of unrefined impure metal, and as the current passes through the acidic electrolyte the anodes are corroded into the solution so that the electroplating process deposits refined pure metal onto the cathodes. The most common electrowon metals are lead, copper, gold, silver, zinc, aluminum, chromium, cobalt, manganese, and the rare-earth and alkali metals. For aluminum, this is the only production process employed. Several industrially important active metals (which react strongly with water) are produced commercially by electrolysis of their pyrochemical molten salts. Experiments using electrorefining to process spent nuclear fuel have been carried out. Electrorefining may be able to separate heavy metals such as plutonium, caesium, and strontium from the less-toxic bulk of uranium. Many electroextraction systems are also available to remove toxic (and sometimes valuable) metals from industrial waste streams. Most metals occur in nature in their oxidized form (ores) and thus must be reduced to their metallic forms. The ore is dissolved following some preprocessing in an aqueous electrolyte or in a molten salt and the resulting solution is electrolyzed. The metal is deposited on the cathode (either in solid or in liquid form), while the anodic reaction is usually oxygen evolution. Several metals are naturally present as metal sulfides; these include copper, lead, molybdenum, cadmium, nickel, silver, cobalt, and zinc. In addition, gold and platinum group metals are associated with sulfidic base metal ores. Most metal sulfides or their salts are electrically conductive and this allows electrochemical redox reactions to efficiently occur in the molten state or in aqueous solutions. Some metals, such as nickel do not electrolyze out but remain in the electrolyte solution. These are then reduced by chemical reactions to refine the metal. Other metals, which during the processing of the target metal have been reduced but not deposited at the cathode, sink to the bottom of the electrolytic cell, where they form a substance referred to as anode sludge or anode slime. The metals in this sludge can be removed by standard pyrorefining methods. Because metal deposition rates are related to available surface area, maintaining properly working cathodes is important. Two cathode types exist, flat-plate and reticulated cathodes, each with its own advantages. Flat-plate cathodes can be cleaned and reused, and plated metals recovered. Reticulated cathodes have a much higher deposition rate compared to flat-plate cathodes. However, they are not reusable and must be sent off for recycling. Alternatively, starter cathodes of pre-refined metal can be used which become an integral part of the finished metal ready for rolling or further processing.

During the recovery step, and in the exemplary electrowinning process, a solution containing copper (electrolyte) is pumped through a bank of cells containing an insoluble anode and a stainless steel cathode. The anode serves as the positive side, cathode the negative. Direct current is passed from the anode through the electrolyte to the stainless steel cathode; this causes the copper ions in solution to plate on to the stainless steel cathode. While timing may vary, in the present invention, depending on the harvesting schedule, copper cathodes are removed every 4-6 days from the stainless steel. Typically, copper cathodes are 99.99% pure and shipped to market. Electrolyte solution that has been depleted of copper is pumped back to the digestion tanks to be reused.

The metal products then may be processed and sold, and other materials, such as cake materials may be sold or disposed of. The disposed materials may still include metals, but such metals would have the desired metals substantially removed, other metals in less quantity. It should be noted that the process of this invention is extremely selective for the type of metal, resulting in typically a purity in excess of 99% for a copper cathode, and most other metal cathodes will also exceed 99% purity, however certain metals that exhibit similar properties may experience more cross contamination. In view of the above, it should be noted that a recycled material is on par with any virgin stock for quality and use.

### Additional Example 1

Copper recovery from a granular feed material including Cu 46%, Fe 24%, Zn 22%. Scoping tests indicate that this material dissolves readily in 10-15% acid solution. An iron pre-treatment step may be required prior to electrowinning, due to the high level or iron. Pretreatment for removal of ferrous materials reduces the amount of iron that is dissolved and generally not easily removable by electrowinning.

Testing consisted of 3 digestion tests, followed by direct electrowinning of 2 of the electrolyte solutions to produce copper cathodes. Chemical analysis of test solutions and residues were also completed and can be seen below. The test confirmed that this material could be digested and the copper electro-won to produce Comex quality copper cathode. The material as described earlier was subjected to a series of steps to separate the copper from the iron as much as possible in order to achieve a high purity copper electrolyte. These steps include digestion, filtration, and carbon absorption before electrowinning with Emew®. Two separate runs were taken with similar procedures with a couple parameters adjusted for comparison. The process for the experiment and the parameters varied can be seen in the table below, with “x” showing steps taken and “−” showing steps not taken.

TABLE 4
(Steps taken for both samples)

| # | Procedure | Sample 1 | Sample 2 |
|---|---|---|---|
| 1 | Wash | — | X |
| 2 | Digest with H₂SO₄ | X | X |
| 3 | Peroxide | X | — |
| 4 | Heat & Stir | X | X |
| 5 | Filtration | X | X |
| 6 | Cake Digest with | X | X |
| | H₂SO₄ | | |
| 7 | Peroxide | X | X |
| 8 | Filtration | X | X |
| 9 | Carbon Filter | X | X |
| 10 | Filtration | X | X |
| 11 | H₂SO₄ & emew ® | X | X |

Sample 1 took 600 g of fresh feed material and added in 400 g of sulfuric acid (H₂SO₄), 2 L of fresh water, and 200 mL of Hydrogen Peroxide (H₂O₂) as the starting solution with a pH of ˜3.5. The mixture was heated and agitated for one (1) hour to destroy any excess H₂O₂ prior to electrowinning. The resulting solution was filtered to separate the copper rich solids (cake) from the iron rich solution. The remaining solids were subjected to a second digestion process using H₂SO₄ and H₂O₂. Peroxide addition was done slowly for several hours to maintain a lower temperature to ensure complete copper dissolution. The peroxide addition step was considered complete when the solids appeared to be fully dissolved in the solution producing a black color. This solution was then filtered to remove any remaining solids, before passing through a carbon column filter to further remove any organics that remained from the original fresh feed. Another filtration was done as an extra precaution before finally running the blue copper solution through the Emew® lab cell at 250 A/m² and 150 A/m². Sulfuric acid was added to the blue solution to ensure sufficient free acid before running through the cell for 5 hours.

Sample 2 used the same procedures generally with half the amount used in steps in Sample 1. A fresh water wash passing through three (3) times was also performed and the first peroxide addition was omitted. The final result after two digesting steps achieved a blue electrolyte solution that was run through the Emew® cell at 250 A/m² for 4 hours. Copper depletion from both samples was 60% and 56% respectively with a final copper cathode purity of 99.99+%.

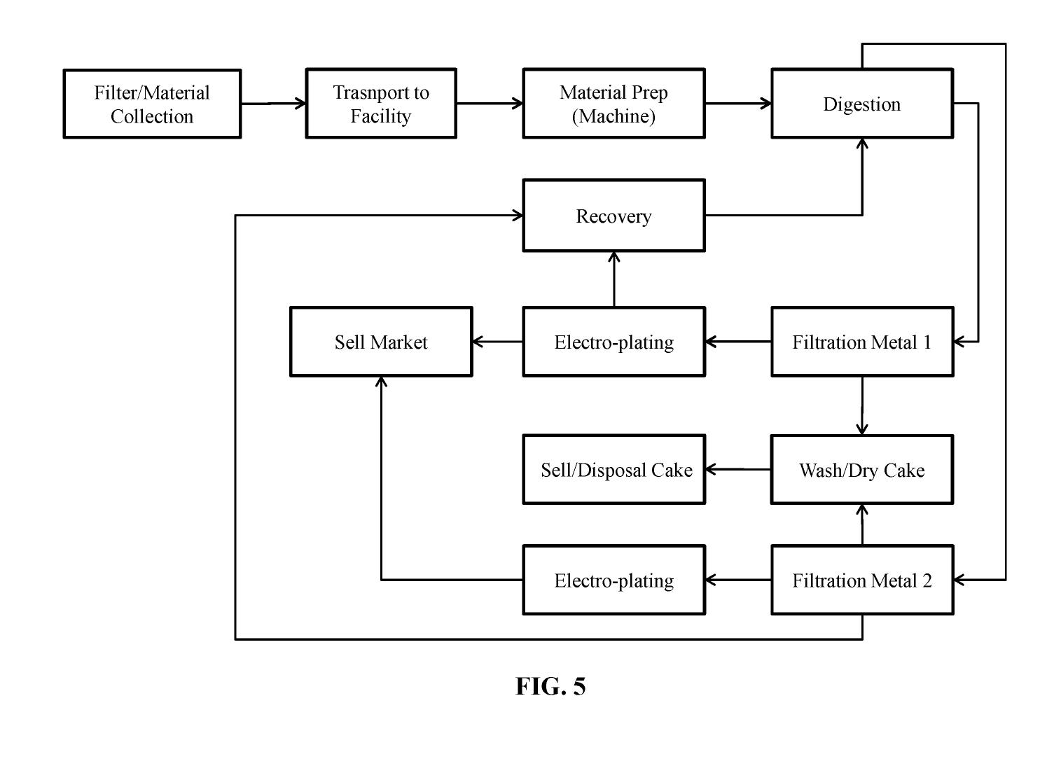

In a sample 3, filter waste material, as described above was processed with a 96% copper recovery and the amount of copper was found to be 12-27% by weight within the filters. The process in FIG. 5, used with sample 3 obtains cake materials before being processed into a copper cathode.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility. The use of the word “said” in the apparatus claims refers to an antecedent that is a positive recitation meant to be included in the coverage of the claims whereas the word “the” precedes a word not meant to be included in the coverage of the claims.

1. A method of recovering metals from a waste material:
collecting the waste material;
processing the waste material;
digesting the processed waste material into a solution; and
electrodepositing a first metal from the solution to create a solid metal product.

2. The method of claim 1 wherein the waste material is industrial filters.

3. The method of claim 2 wherein the industrial filter includes a casing and a filter media, and said step of processing the industrial filter forming the waste material includes the step of separating the outer casing from the filter media and wherein only the filter media is digested as the processed waste material in said step of digesting.

4. The method of claim 3 wherein the step of digesting the filter media as the waste material includes the step of placing the filter media into at least one of an acid or peroxide.

5. The method of claim 4 wherein said step of electrodepositing includes the steps of electrowinning by depositing ions the first metal onto a stainless steel cathode.

6. The method of claim 5 wherein said step of electrodepositing the first metal to create a solid metal product includes the steps of depositing the ions of the first metal onto the stainless steel cathode to create a greater than 99% pure solid metal product.

7. The method of claim 4 wherein said step of electrowinning continues until the solution formed in the digesting step of substantially depleted of ions of the first metal.

8. The method of claim 7 wherein said step of electrowinning is reperformed to electrodeposit a second metal from the solution to create a second solid metal product.

9. The method of claim 7 wherein said step of electrowinning is reperformed for each additional metal to be electrodeposited from solution to create additional solid metal products.

10. The method of claim 1 further including the steps of at least one of heating and stirring during the digesting step.

11. The method of claim 1 further including a filtration step.

12. The method of claim 1 further including a carbon absorption step.

13. The method of claim 11 wherein said carbon absorption step is performed between said digesting and said electrodepositing steps and wherein said carbon absorption step removes organic materials from the solution.

14. The method of claim 11 wherein said filtration step is configured to remove copper rich solids from an iron rich solution during said step of digesting.

15. The method of claim 11 wherein said processing steps include at least one step of stamping, milling, and iron pretreatment steps.

16. A method of recovering metals from industrial filters having a filter media comprising the steps of:
collecting the industrial filters;
processing the industrial filters in preparation for digestion;
digesting the industrial filters into an acidic solution to transfer copper ions from the industrial filters into the acidic solution; and
electrodeposition the copper ions from the solution onto an electrode in the solution.

17. The method of claim 16 further including the step of separating the filter media from any outer casings on the industrial filters.

18. The method of claim 16 wherein said step of processing further includes step of pretreating the filter media to remove iron materials before said step of digesting.

19. The method of claim 16 wherein said step of pretreating includes magnetic removal of iron materials.

20. The method of claim 16 wherein said step of pretreating includes the step of inserting the filter media into an acid and peroxide bath and separating copper rich solids from the iron solution.

21. The method of claim 20 wherein said processing step further includes a carbon column filtration step to remove organic materials.

22. The method of claim 16 wherein said step of electrodeposition includes the step of electrowinning the metal ions from the acidic solution.

23. The method of claim 22 further including a cell configured to hold the acidic solution and an anode and cathode placed into the cell and wherein said step of electrowinning includes circulating the acidic solution in the cell past the anode and cathode to improve purity of a copper being electrodeposited onto the electrode and reducing time required to fully perform said electrodeposition step.

24. The method of claim 23 wherein said step of circulating allows at least 99.9% or greater purity of copper in a solution including multiple metal ions in addition to the copper ions.

25. The method of claim 16 further including performing a second electrodeposition step to remove zinc ions from the solution onto an electrode and wherein said solution is substantially free of copper ions.

26. The method of claim 25 further including performing additional electrodeposition steps to remove additional metal ions from the solution onto an electrode and wherein said solution is substantially free of copper and zinc ions.
